(19) United States
(12) Patent Application Publication
(10) Pub. No.: US 2011/0244298 A1
(43) Pub. Date: Oct. 6, 2011

(54) CELL HOLDER, ENERGY STORAGE CELL, CELL HOLDER STACK AND MULTICELL ENERGY STORE

(76) Inventors: Nevzat Guener, Berlin (DE); Kilian Simbeck, Berlin (DE)

(21) Appl. No.: 13/128,714

(22) PCT Filed: Oct. 30, 2009
(86) PCT No.: PCT/EP09/64339

§ 371 Date: Jun. 16, 2011

(30) Foreign Application Priority Data
Nov. 13, 2008 (DE) 10-2008-057-210.1

(51) Int. Cl. H01M 10/50

(52) U.S. Cl. 429/120

(57) ABSTRACT

A cell holder (1), an energy storage cell, a cell holder stack and a multicell energy store are described. The cell holder is in the form of a housing which is open on one or both sides and is composed of an electrically insulating material, and the cell holder has a rear wall (3) in which a coolant channel (13) is arranged. A plurality of cell holders (1) can be assembled via tongue-and-groove connections (7, 8) to form a cell holder stack, which holds a multiplicity of cells. The cell held therein can be cooled well with the aid of this cell holder (1). Furthermore, it ensures good electrical insulation and good mechanical protection for the cell. The cell holder (1) is particularly suitable for holding lithium-ion cells in the form of softpacks.

### CROSS-REFERENCE TO RELATED APPLICATIONS

This application is a U.S. National Stage Application of International Application No. PCT/EP2009/064339 filed Oct. 30, 2009, which designates the United States of America, and claims priority to German Application No. 10 2008 057 210.1 filed Nov. 13, 2008, the contents of which are hereby incorporated by reference in their entirety.

### TECHNICAL FIELD

The present invention relates to a cell holder for holding and receiving an energy storage cell or two energy storage cells. It is also directed at an energy storage cell provided with such a cell holder, a cell holder stack and a multicell energy store provided with such a cell holder stack.

The present invention relates, in particular, to a cell holder for holding and receiving a lithium ion cell. Lithium ion cells for energy stores for hybrid and electric vehicles exist in various constructions. One construction is the so-called “soft pack”, in which the electrodes are packed with a laminated aluminum foil. These cells have a cuboid construction and can be compactly stacked.

### BACKGROUND

Energy storage cells of this type are put together to form multicell energy stores or multicell batteries. Here, the individual cells are mechanically connected to form a cell stack and are packed in a housing (battery housing). A particular problem is here formed by the cooling of the individual cells. This type of connection of the cells to form a cell stack with packing in a housing, combined with simultaneous cooling of the cells, has hitherto, however, not yet been satisfactorily resolved.

### SUMMARY

According to various embodiments, a cell holder can be provided which allows a mechanical connection of the cells and compact packing of the same in a housing, combined with effective cooling of the cells.

According to an embodiment, a cell holder for holding and receiving an energy storage cell or two energy storage cells, in particular lithium ion cells, can be configured in the form of a housing which is open on one or both sides and is composed of an electrically insulating material and said cell holder having a rear wall in which a coolant channel is arranged, as well as a coolant supply and coolant discharge channel portion, which are arranged on the housing and are connected to the coolant channel, wherein the housing has passages for the current collectors of the cell and is provided with tongue and groove connecting devices for the attachment of further cell holders.

According to a further embodiment, the coolant supply and the coolant discharge channel portion can be arranged on the top side of the housing. According to a further embodiment, the coolant channel can be configured in a serpentine pattern in the rear wall. According to a further embodiment, the housing can be of cuboid configuration and serves to receive a cuboid or two cuboid energy storage cells. According to a further embodiment, the cell holder can be provided with a holding foot portion. According to a further embodiment, the rear wall can be formed by a cooling plate, which consists of two parts connected to each other on their outer side. According to a further embodiment, between the coolant supply and coolant discharge channel portions, the cell holder may have a space for the reception of the associated electronics. According to a further embodiment, on the top side of the coolant supply and coolant discharge channel portions, the cell holder may have a depression for the reception of a band clamp. According to a further embodiment, the cell holder may have a cell holder as described above. According to a further embodiment, a cell holder stack may have a multiplicity of cell holders as described above, which are put together via the tongue and groove connecting devices. According to a further embodiment, the cell holder stack may have two end plates, which close off the stack on both sides. According to a further embodiment of the cell holder stack, the end plates can be provided with coolant supply and coolant discharge connections for the formed coolant supply and coolant discharge channels. According to a further embodiment of the cell holder stack, the cell holder stack can be provided with clamping devices for clamping of the cell holders. According to a further embodiment of the cell holder stack, the cell holder stack may have a multiplicity of cell connectors for the electrical connection of neighboring cells. According to a further embodiment of the cell holder stack, the individual cell holders can be put together at a distance apart for tolerance compensation purposes. According to yet another embodiment, a multicell energy storemay have a cell holder stack as described above. According to a further embodiment, of the multicell energy store, the multicell energy store may have an outer housing, which is fastened to the holding foot of the cell holder stack.

### BRIEF DESCRIPTION OF THE DRAWINGS

The invention is explained in detail below with reference to an illustrative embodiment in conjunction with the drawing, in which:

FIG. 1 shows a three-dimensional representation of a cell holder;

FIG. 2 shows a three-dimensional representation of a cell holder stack;

FIG. 3 shows a schematic top view of a rear wall of a cell holder, the coolant channel arranged in the rear wall being represented schematically; and

FIG. 4 shows a horizontal section through a part of a cell holder in connection with a further cell holder.

### DETAILED DESCRIPTION

According to various embodiments, a cell holder for holding and receiving an energy storage cell or two energy storage cells, in particular lithium ion cells, may be configured in the form of a housing which is open on one or both sides and is composed of an electrically insulating material and said cell holder having a rear wall in which a coolant channel is arranged, as well as a coolant supply and coolant discharge channel portion, which are arranged on the housing and are connected to the coolant channel, wherein the housing has passages for the current collectors of the cell and is provided with tongue and groove connecting devices for the attachment of further cell holders.

Accoridng to various embodiments, thus a cell holder can be provided which simultaneously assumes a plurality of functions. On the one hand, it offers mechanical protection for the cell, since, as a housing, it surrounds the cell. On the other hand, it ensures a cooling of the cell, the appropriate cooling devices being integrated in the cell holder. In addition, it allows a plurality of cells to be mechanically connected to form a mechanically stable cell stack, this connection being enabled by the intended tongue and groove connecting devices. Finally, the packing is achieved in a housing, since the individual cell holders, after the two end sides have been placed one against the other and closed off with appropriate end plates, form a cell holder stack in the form of a closed energy store or battery housing. Furthermore, this inner housing formed by the cell stack can be provided with an outer housing. One particular advantage of the cell holder configured according to various embodiments consists in the fact that it ensures good electrical insulation of the individual cells, to be precise in conjunction with a cooling of the same. The rear wall of the cell holder, which rear wall is designed for cooling purposes, simultaneously ensures the desired electrical insulation. Correspondingly, the side walls of the housing assume corresponding insulating functions. Simultaneous cooling and electrical insulation is thus achieved in a compact manner, since the cell holder housing can be configured with relatively small wall thicknesses. As the material for such a cell holder, appropriate plastics, which are known to the person skilled in the art, are suitable.

The cell holder according to various embodiments is configured in the form of a housing which is open on one or both sides.

It can thus hold and receive a cell or two cells. In the case of the simultaneous reception of two cells, the rear wall ensures the cooling of these two cells, which both abut against the rear wall.

In the rear wall is arranged a coolant channel, which in the operating state of the cell holder is flowed through by a coolant, in particular water. The coolant channel is preferably configured such that the adjacent cell is cooled over broadly the whole of its area. The coolant channel can here, in particular, form a so-called “flow field” and can be configured, for example, in a serpentine pattern in the rear wall.

The supply and discharge of the coolant to and from the coolant channel is ensured by a coolant supply and coolant discharge channel portion, which are arranged on the housing of the cell holder, in particular on the top side thereof. These coolant supply and coolant discharge channel portions, when a plurality of cell holders are lined up in rows or stacked, can be put together to form a coolant supply channel and coolant discharge channel, which supply coolant to the coolant channels in the respective rear walls of the cell holders or lead off coolant therefrom.

Each cell holder is also provided with tongue and groove connecting devices, by means of which further cell holders can be attached to form corresponding cell holder stacks. These tongue and groove connecting devices can be variously configured, provided merely that they allow a plurality of cell holders to be assembled or plugged together in a simple manner. For realization purposes, protruding flanges on one side of a cell holder can cooperate, for example, with grooves on the other side of another cell holder.

In the cell holder configured according to various embodiments, the housing is preferably of cuboid configuration and serves to receive a cuboid or two cuboid energy storage cells. In addition, the cell holder preferably has a holding foot portion, with which a fastening to an outer housing is possible.

The rear wall is expediently formed by a cooling plate, which consists of two parts connected to each other on their outer side, the coolant channel preferably being engraved in a plate part.

Between the coolant supply and coolant discharge channel portions, the cell holder preferably has a space for the reception or accommodation of the associated electronics of the energy store. The housing of the cell holder can also have one or more depressions for the arrangement of clamping devices, for example band clamps, with which clamping devices a formed cell holder stack is held together.

As already mentioned, the cell holder configured according to various embodiments is suitable, in particular, for lithium ion cells which are configured as a soft pack. Such lithium ion cells have a sealing rim, to which a laminated aluminum foil is welded. The sealing rim is folded, so that it fits tightly against the cell. Overall, a cuboid configuration of lithium ion cells is thereby obtained.

The cell holder configured according to various embodiments has a housing which can receive such a cell or two such cells, the current collectors of the cell being guided outward through passages in the housing. Following the insertion of the cell or cells into the cell holder, these current collectors are connected to one another outside of said cell holder.

The tongue and groove connecting devices provided according to various embodiments are expediently configured such that they are able, by overdimensioning, to absorb tolerances in the cell thickness. The cell holders can here be stacked one above the other in an unlimited number, the desired voltage of the multicell energy store being able to be adjusted via a serial connection.

Accoridng to other embodiments, an energy store cell, in particular a lithium ion cell, has a cell holder configured according to various embodiments.

In addition, according to other embodiments, a cell holder stack having a multiplicity of cell holders configured according to various embodiments, which cell holders are assembled or plugged together via the tongue and groove connecting devices. Such a cell holder stack can be formed from an optional number of cell holders. When the cell holders are put together, the coolant supply and coolant discharge channel portions are also put together in a sealed manner, so that continuous coolant supply and coolant discharge channels without leakage losses are formed. For closure on both sides, the cell holder stack preferably has two end plates, which are provided with coolant supply and discharge connections for the formed coolant supply and discharge channels.

In order to hold together the two cell holder stacks, clamping devices, which are preferably elastic, are used. Such clamping devices can be constituted, for example, by band clamps, which are disposed or are arranged in the depressions provided on the housing of the cell holders.

Such a cell holder stack preferably also has a multiplicity of cell connectors for connecting the current collectors of neighboring cells. The assembled cells can thereby be connected in series.

In such a cell holder stack formed from a multiplicity of cell holders, the individual cell holders can be put together at a distance apart for tolerance compensation purposes, in order thereby to be able to receive cells of different thickness.

According to further embodiments, a multicell energy store or a multicell battery having a cell holder stack of the cell holders can be configured according to various embodiments. Such a multicell energy store can also be provided with an outer housing, which is fastened to the holding foot of the cell holder stack, this holding foot being formed by the multiplicity of holding foot portions of the individual cell holders.

The cell holder configured according to various embodiments thus allows the construction of a mechanically stable cell stack, in particular for a hybrid or electric vehicle battery. In this cell stack, the individual cells are mechanically protected against external influences. The corresponding cooling function is integrated in the stack. Because of the preferably thinly configured rear walls of the cell holders, the heat conducting section from the cell to the coolant is very short, whereby very small temperature gradients are formed. The fact that the rear walls or cooling plates can be made very thin produces a gain in installation space compared to other cooling concepts.

The cell inserted in a cell holder can be handled very easily by robots, so that cell stacks are able to be constructed in an automated manner. As the material for the cell holders, cheap plastic can be used. Since no metal parts of any kind are present on the cell holder, considerable advantages are obtained in relation to the required safety tests, since internal short circuits are prevented. Particularly noteworthy is the high-voltage resistance which must be guaranteed for electric vehicles.

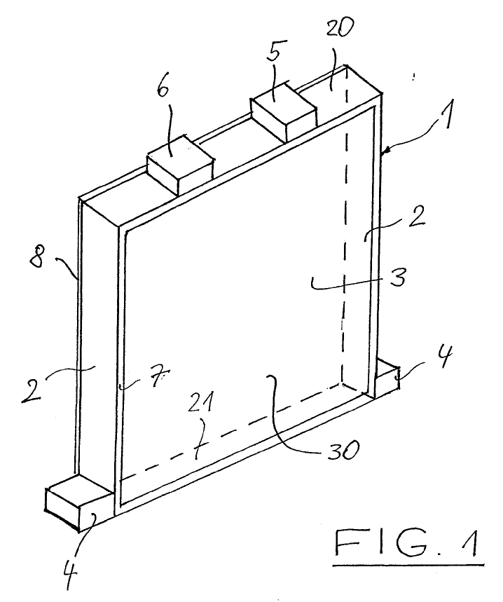

The cell holder 1 represented schematically in three-dimensional view in FIG. 1 has a housing which is open on one side and which in vertical section is of roughly rectangular configuration and has a rear wall 3 and a top wall 20, two side walls 2 and a bottom wall 21. On the top wall 20 are found a coolant supply channel portion 5 and a coolant discharge channel portion 6. These two portions are connected to a coolant channel (not shown) arranged in the rear wall 3 of the cell holder, so that a suitable coolant, for example water, can be supplied via the channel portion 5 and introduced into the coolant channel (not shown). After flowing through the coolant channel, the coolant is led off again via the coolant discharge channel portion 6.

The cell holder 1 also has tongue and groove connecting devices, via which it can be put together with other corresponding cell holders to form a cell stack. These tongue and groove connecting devices are represented schematically at 7 (groove) and at 8 (molding).

The cell holder further has at the bottom ends of its side walls 2 holding foot portions 4, with which it can be fastened to an outer housing.

The cell holder 1 represented in FIG. 1 serves to receive a lithium ion cell, i.e. a so-called “soft pack”, which is accommodated in the free space, represented at 30, in contact with the rear wall 3 flowed through by the coolant. The cell holder consists of a suitable plastics material, which ensures a corresponding electrical insulation of the cell.

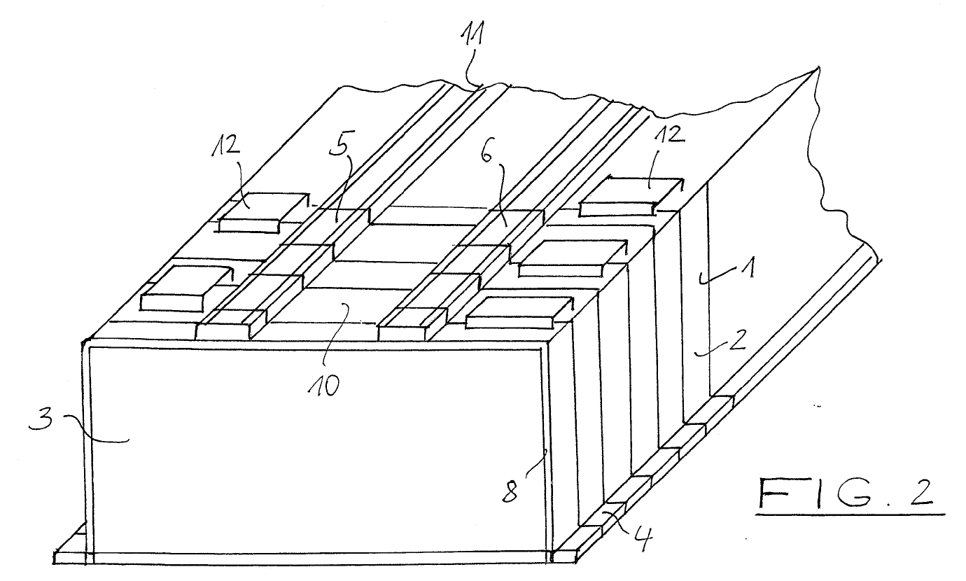

FIG. 2 shows a three-dimensional view of a cell holder stack composed of cell holders 1 of FIG. 1. This cell holder stack is composed of a multiplicity of cell holders 1, which are connected to one another by the tongue and groove connecting devices. In the finished state, the cell holder stack is provided with two end plates (not shown), which have coolant supply and coolant discharge devices 5, 6.

Through the assembly of the individual cell holders, the channel portions 5, 6 are also put together in a sealed manner, producing continuous channels which are connected to the coolant channels 13.

In FIG. 2, grooves 11 on the top sides of the channels 5, 6 are also shown, which grooves serve to receive band clamps with which cell stacks are held together. Cell connectors 12 ensure that the individual cells can be connected in series. The corresponding current collectors of the cells, which extend through the walls of the cell holders, are not represented.

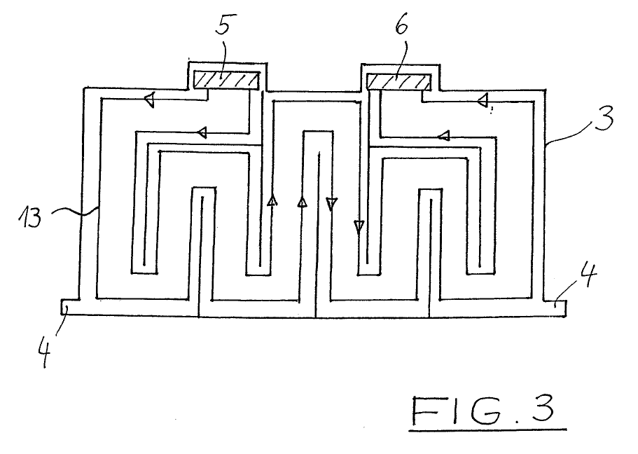

FIG. 3 shows a view of a rear wall 3 of a cell holder 1 with removed front side. It can be seen that within the rear wall 3 there is arranged a serpentine coolant channel 13, which forms a flow field and ensures a broadly even cooling of the rear wall 3. The coolant makes its way from the coolant supply channel portion 5 into the cooling channel 13, flows through the latter and makes its way into the coolant discharge channel portion 6 and is led off from there. In FIG. 3, two coolant channel connections to the coolant supply channel portion and two coolant channel connections to the coolant discharge channel portion are represented. Self-evidently, differently configured flow fields may also, of course, be used.

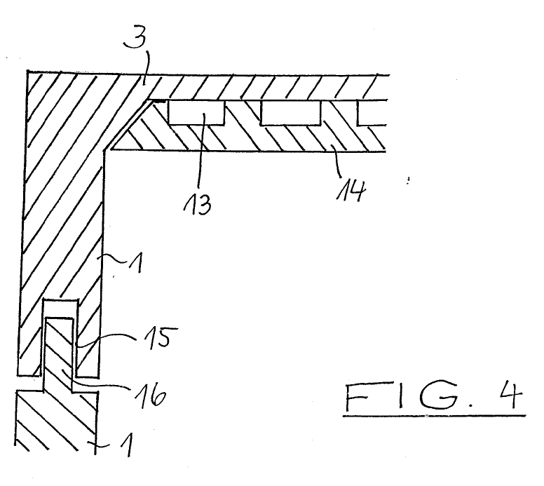

FIG. 4 shows a horizontal section through a part of a cell holder 1 in connection with a further cell holder. It can be seen that the rear wall 3 of the cell holder here consists of two cooling plate portions, of which the inner cooling plate portion 14 has the cooling channel 13, which is engraved in this cooling plate portion. The two plate portions are welded together.

FIG. 4 further shows the tongue and groove connecting devices of the cell holders. The represented cell holder 1 has a groove 15, in which a tongue 16 (molding) of the neighboring cell holder engages. The corresponding connecting devices are configured such that they allow a certain tolerance compensation for cells of different thickness. FIG. 4 shows that the neighboring cell holders are arranged at a distance apart.

What is claimed is:

1. A cell holder for holding and receiving an energy storage cell or two energy storage cells, said cell holder being configured in the form of a housing which is open on one or both sides and is composed of an electrically insulating material and said cell holder having a rear wall in which a coolant channel is arranged, as well as a coolant supply and coolant discharge channel portion, which are arranged on the housing and are connected to the coolant channel, wherein the housing has passages for the current collectors of the cell and is provided with tongue and groove connecting devices for the attachment of further cell holders.

2. The cell holder according to claim 1, wherein the coolant supply and the coolant discharge channel portion are arranged on the top side of the housing.

3. The cell holder according to claim 1, wherein the coolant channel is configured in a serpentine pattern in the rear wall.

4. The cell holder according to claim 1, wherein the housing is of cuboid configuration and serves to receive a cuboid or two cuboid energy storage cells.

5. The cell holder according to claim 1, wherein the cell holder is provided with a holding foot portion.

6. The cell holder according to claim 1, wherein the rear wall is formed by a cooling plate, which consists of two parts connected to each other on their outer side.

7. The cell holder according to claim 1, wherein between the coolant supply and coolant discharge channel portions, the cell holder has a space for the reception of the associated electronics.

8. The cell holder according to claim 1, wherein on the top side of the coolant supply and coolant discharge channel portions, the cell holder has a depression for the reception of a band clamp.

9. An energy storage cell comprising a cell holder according to claim 1.

10. A cell holder stack comprising a multiplicity of cell holders according to claim 1, which are put together via the tongue and groove connecting devices.

11. The cell holder stack according to claim 10, wherein the cell holder stack has two end plates, which close off the stack on both sides.

12. The cell holder stack according to claim 11, wherein the end plates are provided with coolant supply and coolant discharge connections for the formed coolant supply and coolant discharge channels.

13. The cell holder stack according to claim 10, wherein the cell holder stack is provided with clamping devices for clamping of the cell holders.

14. The cell holder stack according to claim 10, wherein the cell holder stack has a multiplicity of cell connectors for the electrical connection of neighboring cells.

15. The cell holder stack according to claim 10, wherein the individual cell holders are put together at a distance apart for tolerance compensation purposes.

16. A multicell energy store comprising a cell holder stack according to claim 10.

17. The multicell energy store according to claim 10, wherein the multicell energy store has an outer housing, which is fastened to the holding foot of the cell holder stack.

18. The cell holder according to claim 1, wherein the energy store cell is a lithium ion cell.

19. The cell holder stack according to claim 10, wherein each energy store cell is a lithium ion cell.

20. The multicell energy store according to claim 16, wherein each energy store cell is a lithium ion cell.
